(19) United States
(12) Patent Application Publication
(10) Pub. No.: US 2014/0292525 A1
(43) Pub. Date: Oct. 2, 2014

(54) INDICATION CIRCUIT FOR INDICATING ROTATION SPEED OF FANS

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/135,657

(22) Filed: Dec. 20, 2013

(30) Foreign Application Priority Data
Mar. 28, 2013 (CN) 2013101037761

(51) Int. Cl. G08B 5/36

(52) U.S. Cl. CPC G08B 5/36
USPC 340/671

(57) ABSTRACT

An indication circuit for indicating the rotation speeds of fans of a server includes a connector, a microprocessor, a number of light emitting diodes (LEDs) and resistors which correspond to the LEDs one-to-one. The connector is connected to the fans. The microprocessor is connected to the connector and utilized to receive the rotation speed signals of the fans from the connector. A cathode of each LED is connected to a corresponding output terminal of the microprocessor through a resistor, and anodes of the LEDs are connected to a power source.

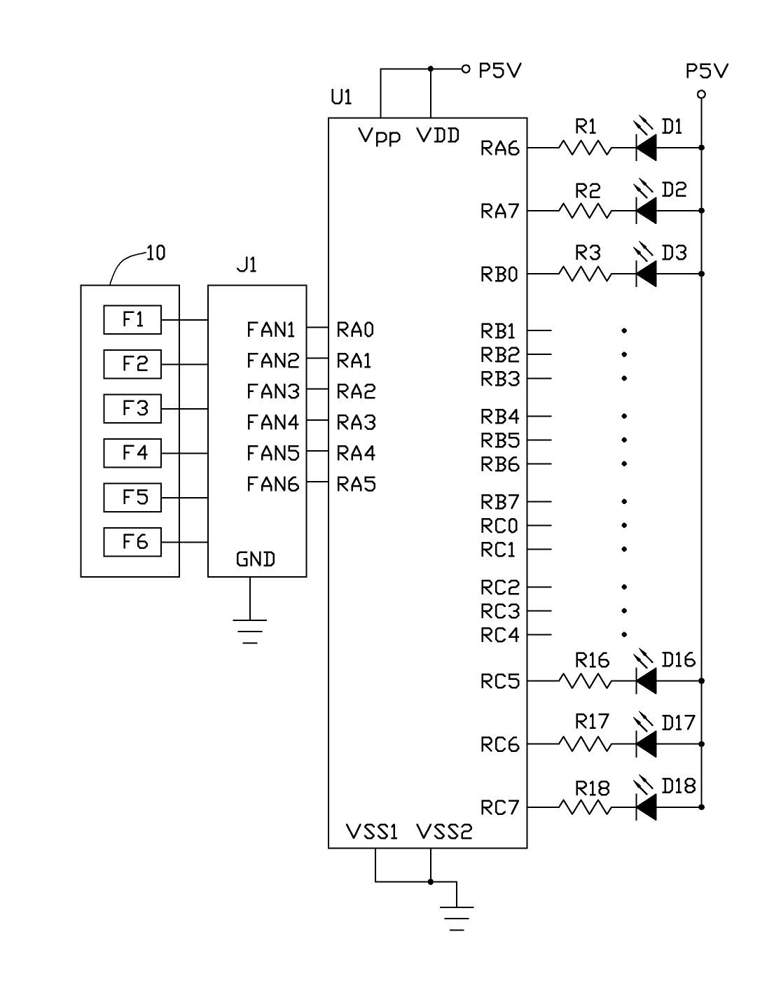

### BACKGROUND

1. Technical Field

The present disclosure relates to indication circuits and, particularly, to an indication circuit for indicating rotation speeds of fans.

2. Description of Related Art

Fans are commonly used to cool electronic devices. The fans of an electronic device are arranged inside of the electronic device, and are hidden from users, thus users cannot know whether the fans are operating normally.

Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The figure is a circuit diagram of an indication circuit for indicating the rotation speeds of fans, in accordance with an embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

The figure shows an embodiment of the present disclosure of an indication circuit for indicating the rotation speeds of fans of a server 10. In the embodiment, the fans comprise first to sixth fans F1-F6 which have three different levels of rotation speeds, such as a low rotation speed level which is less than 1000 revolution per minute (rpm), a medium rotation speed level which ranges from 1000 rpm to 2000 rpm, and a high rotation speed level which is greater than 2000 rpm. The indication circuit comprises a connector J1 connected to the first to sixth fans F1-F6 for outputting first to sixth rotation speed signals, a microprocessor U1 connected to the connector J1 for receiving the first to sixth rotation speed signals, eighteen light emitting diodes (LEDs) D1-D18, and eighteen resistors R1-R18 which correspond to the LEDs D1-D18 one-to-one. A cathode of each LED is connected to a corresponding output terminal of the microprocessor U1 through a corresponding one of the resistors R1-R18. An anode of each LED is connected to a power source P5V.

The connector J1 comprises first to sixth output terminals FAN1-FAN6 for outputting the first to sixth rotation speed signals, respectively. A ground terminal GND of the connector J1 is grounded. The microprocessor U1 comprises first to sixth input terminals RA0-RA5 connected to the first to sixth output terminals FAN1-FAN6 of the connector J1, respectively, for receiving the first to sixth rotation speed signals. First and second power terminals Vpp and VDD of the microprocessor U1 are connected to the power source P5V. First and second ground terminals VSS1 and VSS2 of the microprocessor U1 are grounded. The microprocessor U1 also comprises first to eighteenth output terminals RA6, RA7, RB0-RB7, RC0-RC7 connected to the cathodes of the LEDs D1-D18 through the resistors R1-R18, respectively.

The microprocessor U1 is utilized to determine the rotation speed level of the fans F1-F6 according to the received first to sixth rotation speed signals, and output control signals to the corresponding LEDs D1-D18 through the output terminals RA6, RA7, RB0-RB7, RC0-RC7. Every three of the LEDs D1-D18 are respectively utilized to indicate the rotation speed of one of the first to sixth fans F1-F6 in three different speed levels.

Taking the first fan F1 as an example to show the principle of the indication circuit.

In use, the first input terminal RA0 of the microprocessor U1 receives the first rotation speed signal from the first output terminal FAN1 of the connector J1. When the first rotation speed of the first fan F1 is within the low rotation speed level, the first output terminal RA6 of the microprocessor U1 outputs a low level signal, such as logic 0, and the second and the third output terminals RA7 and RB0 of the microprocessor U1 output high level signals, such as logic 1. The LED D1 is lit and the LEDs D2 and D3 do not light, to indicate the first fan F1 is operating at the low rotation speed level.

When the first rotation speed of the first fan F1 is within the medium rotation speed level, the second output terminal RA7 of the microprocessor U1 outputs a low level signal, and the first and the third output terminals RA6 and RB0 of the microprocessor U1 output high level signals. The LED D2 is lit and the LEDs D1 and D3 do not light, to indicate the first fan F1 is operating at the medium rotation speed level.

When the first rotation speed of the first fan F1 is within the high rotation speed level, the third output terminal RB0 of the microprocessor U1 outputs a low level signal, and the first and the second output terminals RA6 and RA7 of the microprocessor U1 output high level signals. The LED D3 is lit and the LEDs D1 and D3 do not light, to indicate the first fan F1 is operating at the high rotation speed level. Therefore, the work states of the fan F1-F6 can be displayed by the LEDs D1-D18 to users.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An indication circuit for indicating rotation speeds of fans of a server, the indication circuit comprising:
a connector connected to the fans for receiving and outputting rotation speed signals of the fans;
a microprocessor connected to the connector for receiving the rotation speed signals;
a plurality of resistors; and
a plurality of light emitting diodes (LEDs), wherein a number of the plurality of LEDs is same with a number of the plurality of resistors, a cathode of each LED is connected to a corresponding output terminal of the microprocessor through a corresponding one of the resistors, an anode of each LED is connected to a power source;
wherein the microprocessor determines the rotation speed level of the fans according to the received rotation speed signals, and outputs control signals to the corresponding LEDs, the LEDs respectively indicate the rotation speed of a fan in different speed levels.

2. The indication circuit of claim 1, wherein the connector comprises first to sixth output terminals for receiving and outputting first to sixth rotation speed signals from first to sixth fans of the server, the microprocessor comprises first to sixth input terminals which are connected to the corresponding first to sixth output terminals of the connector, for receiving the first to sixth rotation speed signals, respectively, the microprocessor also comprises first to eighteenth output terminals each connected to a cathode of a corresponding LED through a corresponding one of the first to eighteenth resistors of the plurality of resistors, every three of the first to eighteenth LEDs indicate the rotation speed of a corresponding fan in three different speed levels.

3. The indication circuit of claim 2, wherein when the rotation speed of one of the fans is at a certain speed level, the corresponding one of the three output terminals of the microprocessor outputs a low level signal, and the other two output terminals of the microprocessor output high level signals.

4. The indication circuit of claim 2, wherein the connector further comprises a grounded terminal.

5. The indication circuit of claim 2, wherein the microprocessor further comprises first and second power terminals connected to the power source, and first and second ground terminals grounded.
